(19) United States
(12) Patent Application Publication
(10) Pub. No.: US 2009/0219148 A1
(43) Pub. Date: Sep. 3, 2009

(54) WIRELESS VEHICLE TRAILER MONITORING AND CONTROL SYSTEM

(75) Inventors: Donald A. Thomas, Columbiana, OH (US); Henry Limoge, Vista, CA (US); Thomas Abrhams, Saolomish, WA (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: DONALD THOMAS, LLC, Columbiana, OH (US)

(21) Appl. No.: 12/260,457

(22) Filed: Oct. 29, 2008

Related U.S. Application Data
(60) Provisional application No. 60/983,398, filed on Oct. 29, 2007.

(51) Int. Cl. G08B 21/00

(52) U.S. Cl. 340/431

(57) ABSTRACT

A wireless trailer monitor and control system is configured to monitor and control various electrical system within a trailer. The system employs a wireless interface for communication of monitoring and/or controlling information between the trailer and an associated towing vehicle.

### RELATED APPLICATION DATA

This application claims priority of U.S. Provisional Application No. 60/983,398, filed on Oct. 29, 2007, which is incorporated herein by reference in its entirety.

### TECHNICAL FIELD OF THE INVENTION

The present invention relates generally to vehicle trailer equipment, and, more particularly, to a wireless vehicle trailer monitoring and control system.

### BACKGROUND

Each day over a million trailers, e.g., box trailers, boat trailers, caravans and the like, are towed on the nation's highways. With over a million trailers being towed on the nation's highways, million's of dollars in personal property are being towed across the nation. Personal property can range from personal luggage to private watercrafts. These items can be towed by vehicles ranging from diesel vehicles to small luxury SUV's. Thus, the towing of personal belongings is a common way to transfer massive amounts of goods from one location to another.

Typically, trailers include lighting systems, e.g., tail lights, brake lights, turn signal lights, etc., as well as electric braking systems. From time to time, various fault conditions may occur with the trailer lighting and/or braking systems. For example, a lamp on the trailer may fail or the electric brakes may become disconnected or otherwise fail. Because trailer lamps are not visible to the driver of the towing vehicle, the driver may continue to drive without knowing that a trailer lamp has failed. Similarly, the trailer's brakes may become disconnected or otherwise fail without the driver being aware of the fault condition.

### SUMMARY

One aspect of the present invention relates to a wireless vehicle-to-trailer monitoring and control system. The wireless monitoring and control system is configured to provide transfer of monitoring and/or control information between the trailer and the towing vehicle without hard wiring between the trailer and the towing vehicle. The wireless monitoring and control system may be configured to operate by interfacing with already-existing towing vehicle hardware and already-existing trailer controllers.

One aspect of the invention relates to a wireless vehicle trailer monitoring system that includes a monitoring circuit operatively coupled to a trailer controller, the monitoring circuit configured to detect a fault condition with an associated trailer, a trailer wireless transceiver operatively coupled to the monitoring circuit, and a towing vehicle wireless transceiver operatively coupled to an associated towing vehicle, wherein the trailer wireless transceiver is configured to communication wirelessly with the towing vehicle wireless transceiver.

Another aspect of the invention relates to a wireless vehicle trailer monitoring system that includes a monitoring circuit operatively coupled to a portion of an associated trailer, the monitoring circuit configured to detect a fault condition with the associated trailer, a trailer wireless transceiver operatively coupled to the monitoring circuit, and a towing vehicle wireless transceiver operation coupled to an associated towing vehicle, wherein the trailer wireless transceiver is configured to communicate wirelessly with the towing vehicle wireless transceiver.

Another aspect of the invention relates to a wireless vehicle trailer control system that includes a towing vehicle wireless transceiver operatively coupled to a control harness of a towing vehicle, and a trailer wireless transceiver operatively coupled to a trailer controller, the trailer wireless transceiver configured to receive wireless trailer control signals from the towing vehicle wireless transceiver.

Another aspect of the invention relates to a wireless brake monitoring system for a vehicle trailer that includes a trailer brake monitoring circuit configured to cooperate with an associated trailer brake controller and to detect a trailer brake failure condition, a trailer wireless transceiver operatively coupled to the trailer brake monitoring circuit, a vehicle transceiver operatively coupled to an associated towing vehicle, the first vehicle transceiver being configured to communicate wirelessly with the trailer wireless transceiver.

Another aspect of the invention relates to a trailer having lights, electric brakes and a trailer controller operatively coupled to the lights and electric brakes. The trailer includes a trailer fault detection circuit operatively coupled to the trailer controller, the trailer fault detection circuit configured to detect a fault condition with the lights and/or electric brakes of the trailer, and a wireless transceiver operatively coupled to the trailer fault detection circuit, the transceiver being configured to wirelessly transmit fault detection information to a transceiver associated with a towing vehicle.

Another aspect of the invention relates to a trailer monitoring apparatus that includes a trailer fault detection circuit operatively coupled to a trailer controller, the trailer fault detection circuit configured to detect a fault condition an electrical system of a trailer, and a wireless transceiver operatively coupled to the trailer fault detection circuit, the transceiver being configured to wirelessly transmit fault detection information to a transceiver associated with a towing vehicle.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of features of the other embodiments.

### BRIEF DESCRIPTION OF THE DRAWINGS

Many aspects of the invention can be better understood with reference to the following drawings. The components of the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is a diagrammatic illustration of towing vehicle and a trailer employing a wireless trailer monitoring and control system;

FIG. 2 is a diagrammatic illustration of an exemplary bits profile that may be employed in connection with the disclosed technology;

FIG. 3 is a diagrammatic illustration of an exemplary data stream that may be employed in connection with the disclosed technology;

FIG. 4 is an electrical schematic of an exemplary trailer brake monitor circuit for use in connection with the disclosed technology;

FIG. 5 is a diagrammatic illustration of an exemplary wireless trailer monitor and/or control system;

FIG. 6 is a diagrammatic illustration providing a detailed view of a portion of FIG. 5;

FIG. 7 is a diagrammatic illustration providing a detailed view of a portion of FIG. 5;

FIG. 8 is a diagrammatic illustration providing a detailed view of a portion of FIG. 5;

FIG. 9 is a diagrammatic illustration of an exemplary status module in accordance with one embodiment; and

FIG. 10 is a diagrammatic illustration of an exemplary status module in accordance with another embodiment.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Aspects of the disclosed technology relate to a wireless trailer monitoring and control system that is configured to detect electrical fault conditions occurring with a trailer and alert the driver of a towing vehicle to such electrical fault conditions. The system makes use of monitoring and/or detection circuitry and a wireless interface to enable wireless transmission of such fault conditions to a driver of a towing vehicle without any hard wiring existing between the towing vehicle and the trailer. A further aspect of the disclosed technology relates to a wireless brake and/or lighting control system in which the trailer brakes and/or lights may be controlled by way of a wireless interface between the trailer and the towing vehicle.

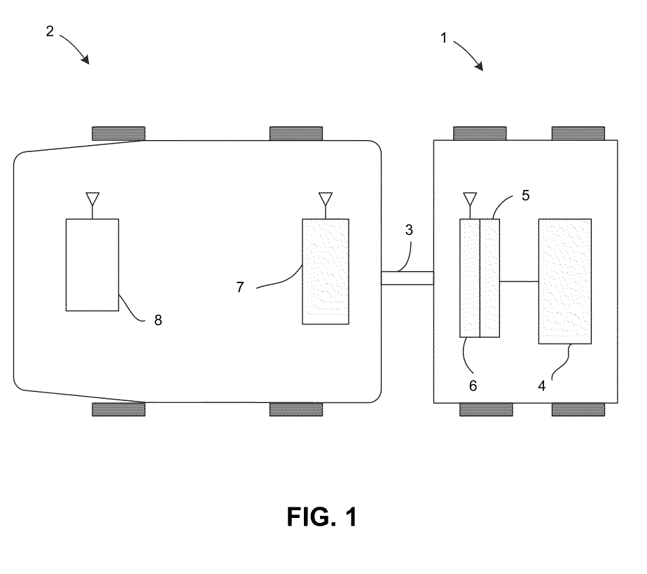

FIG. 1 illustrates a trailer 1 being towed by a vehicle 2 by way of a suitable hitch assembly 3. The trailer 1 includes a trailer harness (shown schematically as 4) made up of various electrical systems within the trailer, e.g., an electric brake system and various lighting systems. The harness 4 is operatively coupled to one or more monitoring circuits (also referred to as detection circuits or fault detection circuits) 5. The monitoring circuitry is operatively coupled to or otherwise integrated with a first transceiver (also referred to as a trailer transceiver) 6. The trailer transceiver 6 is configured to wirelessly communicate with an associated first towing vehicle transceiver 7, which is operatively coupled to a portion of an associated towing vehicle, for example, to a portion of a harness of the towing vehicle. The first towing vehicle transceiver 7 is configured to wirelessly communicate with a driver alert or status module 8, whereby the driver alert or status module 8 is integrated with or operatively coupled to a transceiver. As is discussed more fully below, the wireless system may be employed for a variety of trailer monitoring and/or controlling functions.

It will be appreciated from the following discussion that the wireless communication platform described herein may be employed for or in connection with one or more of the following applications: wireless monitoring of lighting fault conditions occurring with the trailer, e.g., malfunctioning tail lights, brake lights or turn signal lights, a wireless system for monitoring trailer brake malfunction, a wireless system for controlling lighting and/or braking of a trailer, a wireless system for monitoring and/or controlling stability or yaw associated with the trailer, a wireless system for monitoring the status of a coupler and a connection point between a towing vehicle and a trailer, a wireless system for monitoring cargo-related activity, e.g., tongue weight or status of cargo disposed within the trailer, and the like.

In one embodiment, a wireless trailer harness monitoring system is provided. The monitoring system may be configured to monitor the functioning of all trailer lights, e.g., tail lights, brake lights, turn signal lights or the like. The monitoring system may be configured such that a trailer transceiver interfaces with the existing four-wire trailer harness system. The monitoring system will alert the driver of the towing vehicle if there is a problem with the trailer lighting converter or with the trailer lighting itself.

To determine if the harness system is in working condition, the monitoring system may make use of high-side current sensors in line with a suitable resistor, e.g., a 0.01 ohms resistor, as the shunt, to determine if a proper amount of current is passing through. Each time a proper current passes through, it will flag the section of the harness as good.

To determine if the trailer bulbs are damaged, a pull-up resistor may be employed on the signal wires. If there is a damaged or otherwise defective bulb, that line will not be able to pull down the voltage on the pull-up resistors.

Any suitable transmitter, receiver or transceiver may be employed for the trailer transceiver and the towing vehicle transceiver. One suitable type of transmitter/receiver is the type often used in connection with automotive wireless keyless entry. For example, a TXC2 transmitter and/or a RXA3 receiver may be employed. Both are available from Spirit-On Enterprise Co., Ltd. Using these types of transmitters/receivers, the carrier frequency may be centered at 433.92 MHz using Amplitude Shift Keying (ASK) or sometimes called On-Off Keying (OOK) as the modulation.

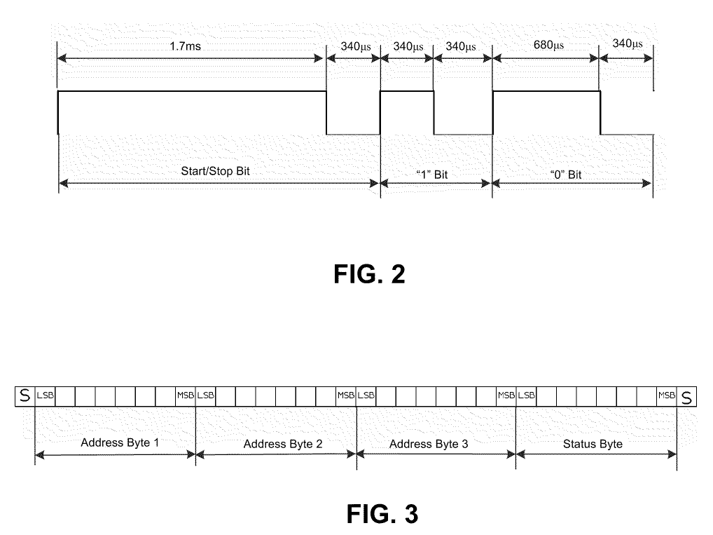

Wireless communication between the trailer transceiver and the towing vehicle transceiver may be accomplished via variable pulse width modulation (PWM) encoding to encode the bits to be sent over. FIG. 2 provides an exemplary bits profile that may be employed in connection with the disclosed technology.

In one embodiment, there will be a total of four bytes to be sent, excluding start/stop bits. Three bytes may be used for the unit's address. Each pair has a unique address to prevent cross over talk when two pairs are in close proximity with each other. The last byte is the status byte.

TABLE 1
Status Byte

| Bit | Function |
|---|---|
| 0 | Left Bulb Good |
| 1 | Left Bulb Bad |
| 2 | Right Bulb Good |
| 3 | Right Bulb Bad |
| 4 | Taillight Bulb Good |
| 5 | Taillight Bulb Bad |
| 6 | Transmitter Online |
| 7 | Low Battery Indicator |

Transmission of data may be accomplished by sending the least significant bit first. FIG. 3 provides an exemplary data stream that may be employed in connection with the disclosed technology.

The trailer transmitter/transceiver (and associated fault detection circuitry) will check the left, right and tail signal in real-time, but may only transmit if there is a change in the harness. In one embodiment, if there is no change for five seconds, for example, the transmitter/transceiver will transmit just to let the receiver know that it's still online. If the towing vehicle receiver/transceiver does not receive any data from the transmitter for twelve seconds, for example, then the transmitter will display an error to notify the driver.

Appendix A provides an exemplary wireless monitor truth table that may be employed in connection with aspects of the present invention.

In accordance with another embodiment, the wireless monitoring system may be configured as a wireless brake monitoring system used in connection with a trailer electric brake controller. A trailer brake monitoring circuit may be connected in series with a standard trailer electric brake controller, thereby providing an audible and/or a visual alarm if the trailer electric brakes become disconnected. As is discussed more fully below, the wireless trailer brake monitoring system may operate in conjunction with a pulse width modulation (PWM) output from a standard trailer brake controller. In one embodiment, a sensor in series with the PWM output device, a PNP power transistor, provides a voltage level to a comparator circuit which controls a RED LED visual indicator. A separate comparator circuit monitors the output directly and with proper output connections, illuminates a GREEN LED.

In the event of trailer brake discontinuity, an audible alarm may be sounded for a predetermined amount of time, e.g., for 3-5 seconds, the GREEN LED may be inhibited, and the RED LED may blink for 3-5 seconds in sync with the audible alarm and then be subsequently illuminated to maximum intensity until the discontinuity is corrected.

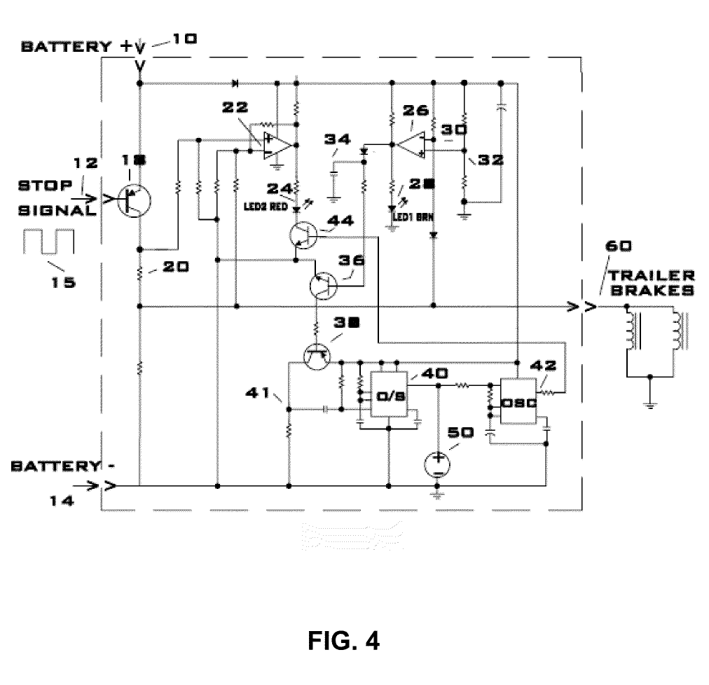

Turning now to FIG. 4, an electrical schematic of a trailer brake monitoring circuit for use in connection with a trailer brake monitoring device is provided. The monitoring circuit is operative to wirelessly communicate trailer brake disconnection information to the towing vehicle in the form of visual and/or audible alarms in the event of disconnection or malfunction of the trailer brakes.

Four (4) connections are made, Battery+(10), Battery−(14), Stop signal from the brake controller (12), and an output to the trailer brakes (60).

At quiescence, i.e., no stop signal is present, there is no current through sensor (20) and no voltage is applied to the non-inverting input of comparator (22). Thus the output of comparator (22) is LO, inhibiting RED LED (24). The non-inverting input (32) of comparator (26) is referenced at a level above ground. There is no voltage to the trailer brakes (60) which is monitored by the inverting input (30) of comparator (26). Thus the output of comparator (26) is HI, illuminating GREEN LED (28) and charging integrator capacitor (34) which enables NPN transistor (36) which enables PNP transistor (38), holding the trigger input (41) HI to One-shot (40). This precludes One-shot (40) from operating which maintains a LO output to the audio alarm (50) and Oscillator (42) trigger. In summary, in quiescence, the GREEN LED is illuminated, the RED LED and the audio alarm are inhibited.

When a PWM (15) STOP signal (12) is present, a positive voltage is developed across sensor (20), switching the output of comparator (22) HI and illuminating RED LED (24) in proportion to the PWM signal. The GREEN LED remains illuminated due to the AC component of the output to the trailer brakes, which inhibits the audio alarm.

When the trailer brake output (60) sees a discontinuity, the resulting high impedance results in a DC level at the inverting input of comparator (26). Thus comparator (26) output is switched LO, turning “off” GREEN LED (28), inhibiting NPN transistor (36) and thus PNP transistor (38) which triggers One-shot (40) for 3-5 seconds. The audio alarm (50) is activated and Oscillator (42) is enabled which blinks RED LED (24) for 3-5 seconds. When One-shot (40) times out, Oscillator (42) output remains HI, enabling the RED LED to maximum illumination until the discontinuity is corrected.

Trailer electric brake controllers provide visual indication of power levels applied to the trailer electric brakes. This level is determined by the pulse width and is set by the operator with manual control of the brake controller to obtain optimum braking of the trailer. This visual indicator does not alert the driver if the trailer electric brakes become disconnected. The trailer brake monitor provides both a visual and audible alarm.

The trailer brake monitor may be connected in series with a standard trailer electric brake controller, thereby providing both an audible and visual alarm if the trailer electric brakes become disconnected.

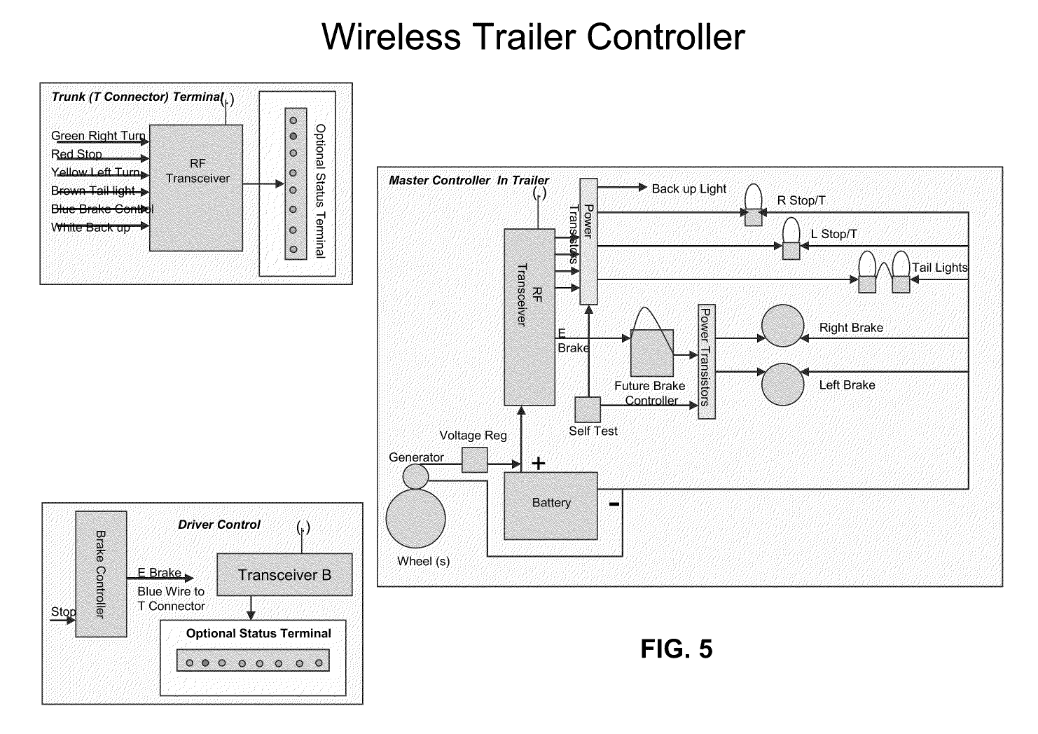

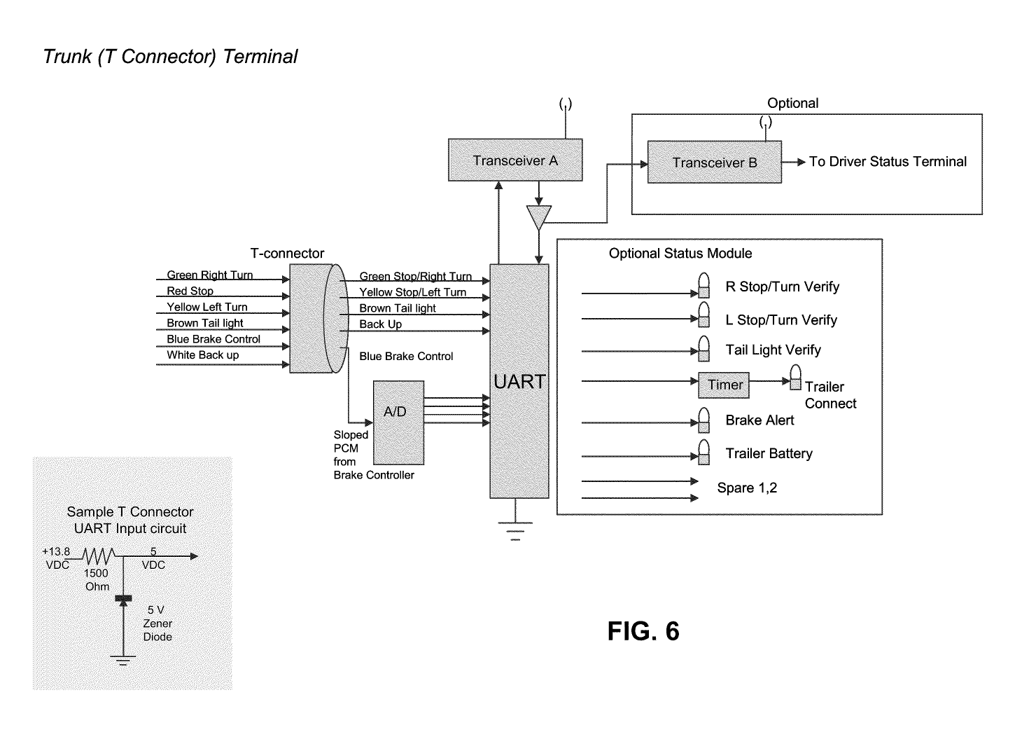

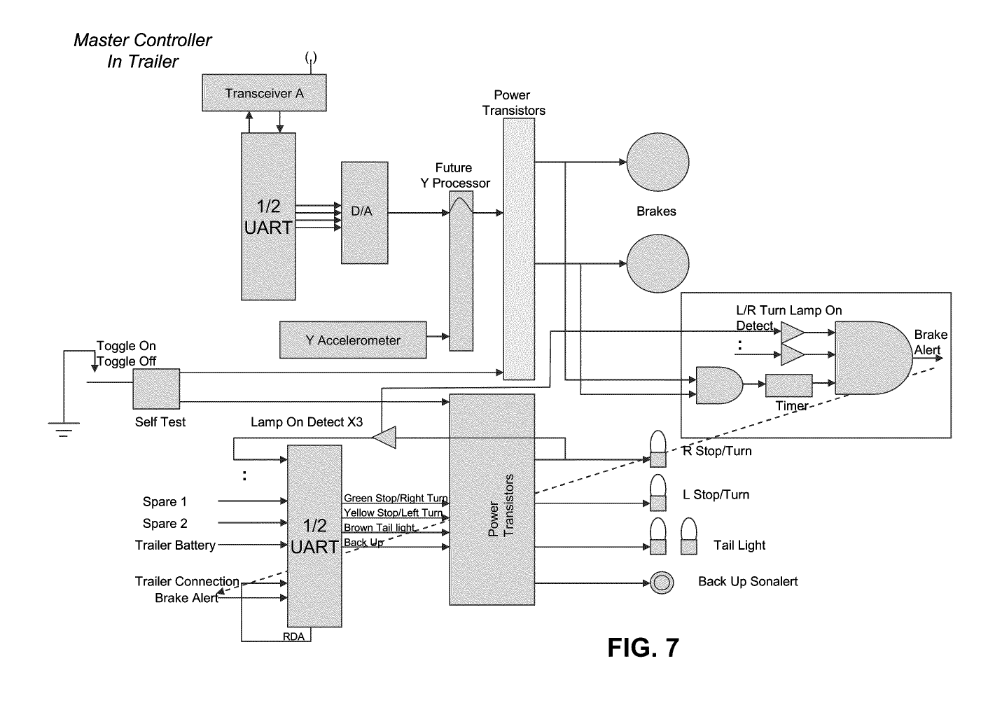

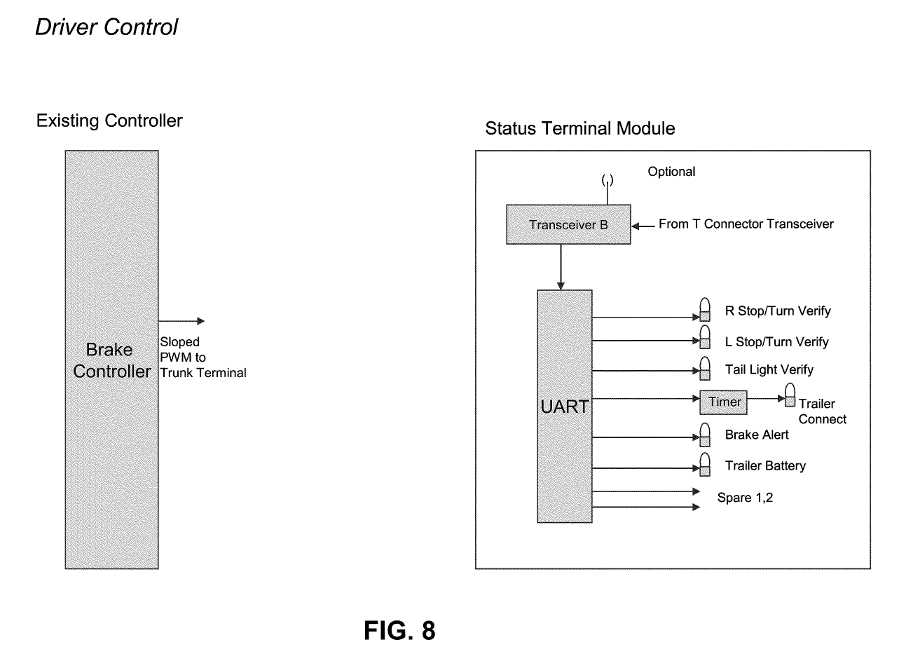

Turning now to FIGS. 5-8, an exemplary wireless trailer monitoring and control system is provided. The wireless trailer monitoring and control system includes a trailer controller portion in which a control and/or monitoring circuit is operatively coupled to, in a preferred embodiment, an existing trailer control circuit by plugging the trailer detection and transceiver circuit into the trailer control harness. A towing vehicle control terminal includes a radio frequency transceiver operatively coupled to a portion of the vehicle harness, for example, using a standard connection to a T Connector in the trunk of the towing vehicle. A driver control and/or alert module includes a wireless transceiver that is configured to communicate with the trunk transceiver and, optionally, includes one or more status indicators to communicate status information to a driver of the towing vehicle. FIG. 6 shows a more detailed schematic of an exemplary trunk (T Connector) terminal and FIG. 7 shows a more detailed view of an exemplary master controller in the trailer. FIG. 8 provides a more detailed view of an exemplary driver control and/or alert module, including the status terminal module.

Upon establishment of the herein described wireless platform for trailer monitoring and/or control, it will be appreciated that a variety of other applications may be accomplished using the wireless system. For example, as is described above, the wireless system may be employed for controlling lighting and/or braking of the trailer.

In addition, it will be appreciated that the wireless system (and the components within the system) may be modified to accomplish other control and/or monitoring functions without departing from the scope of the present invention. For example, by providing appropriate sensors and/or control modules, the trailer's side-to-side motion or yaw may be monitored and controlled to provide a more stable operation of the trailer. In another example, where the connection point between the towing vehicle and the trailer may include a coupling mechanism having electronic components, the status of the coupler may also be monitored by way of the wireless system. For example, a suitably-enabled electronic coupler may provide data as to the force with which the coupler is held onto the hitch. In the case where the force drops below a predetermined threshold, an alert or fault signal may be relayed wirelessly to the driver by way of the status or alert module.

In yet another application, the wireless system may be employed in the monitoring of cargo-related activity. For example, with the use of appropriate force sensors, the tongue weight of the trailer may be monitored and wirelessly communicated to the driver, e.g., by displaying the information on the driver status/alert module. If the tongue weight is found to exceed a predetermined threshold, an alarm may be presented to the driver, at which point, the driver can take appropriate action to remedy the situation.

Further, in a system in which stability of the cargo may be monitored, such stability information may be wirelessly communicated to the driver by way of the wireless monitoring and/or control system described herein. For example, in the case of a motorcycle being towed within the trailer, it may be possible with use of appropriate force sensors to monitor the pressure points on harness members securing the motorcycle within the trailer. If it is determined that one or more of the pressure points falls outside of a predetermined tolerance range, an alarm signal may be wirelessly communicated to the driver alert module. In yet another cargo-related embodiment, the trailer and the towing vehicle may be configured such that a “quick-look camera” and light source is employed. In this exemplary embodiment, the driver may be able to indicate a desire for a “quick look” at the cargo. Upon actuation of an appropriate control function, a light source may illuminate the cargo and an appropriate camera may capture an image of the cargo, whereby the image of the cargo is wirelessly transmitted to the driver alert module for display on the module. Other applications may become apparent to one of ordinary skill in the art upon a reading and understanding of this detailed description.

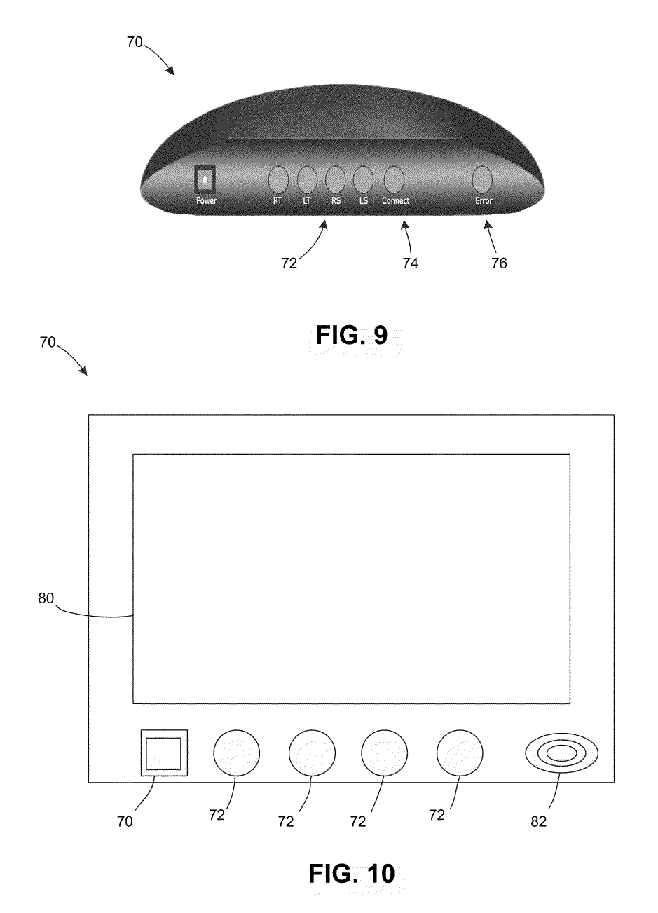

Turning now to FIGS. 9 and 10, it will be appreciated that the driver alert module may take on a variety of forms depending on the particular functions being carried out by the wireless monitoring and/or control system. For example, FIG. 9 shows an exemplary driver alert module 70 having a plurality of status indicator lights, e.g., LEDs, with each status light representing the status of a different trailer electrical component. For example, in the case of monitoring the lighting of the trailer, the driver alert module may include one status indicator LED 72 for each light within the trailer, for example, a right turn light, a left turn light, a right brake light, a left brake light, and the like. Also, the driver alert module may include a status indicator light 74 that indicates and/or verifies that the trailer is still connected to the towing vehicle. In addition, the driver alert module may include an error light 76, which, when in a red or fault state, would be indicative of an error with the wireless communication system. Of course, it will be appreciated that the invention is not limited to any particular configuration and/or number of status indicator lights on the driver alert module.

Further to this point, FIG. 10 provides an alternative exemplary embodiment of a driver alert or status module 70. In this case, the driver alert module includes a display screen 80 on which a variety of different information can be displayed, including, but not limited to, information related to tongue weight, cargo stability, brake fault status, trailer lighting status, and the like. The exemplary driver alert module with display may also include a plurality of status indicator lights 72 as well as a general error light and a speaker 82 through which an alert may be sounded, for example, if it is detected that the trailer brakes are disconnected or otherwise in a fault condition.

It will be appreciated that the provision of a wireless system for trailer monitoring and/or control may provide numerous advantages, such as simplified communication between a trailer and a towing vehicle. In addition, the provision of a wireless system for trailer control and/or monitoring facilitates enhanced control of trailer operations.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A wireless vehicle trailer monitoring system comprising:
a monitoring circuit operatively coupled to a trailer controller, the monitoring circuit configured to detect a fault condition with an associated trailer;
a trailer wireless transceiver operatively coupled to the monitoring circuit; and
a towing vehicle wireless transceiver operatively coupled to an associated towing vehicle, wherein the trailer wireless transceiver is configured to communication wirelessly with the towing vehicle wireless transceiver.

2. The wireless vehicle trailer monitoring system according to claim 1, further comprising:
a driver alert module configured to wirelessly receive fault condition information from the towing vehicle wireless transceiver and to display the received fault condition information.

3. A wireless vehicle trailer monitoring system comprising:
a monitoring circuit operatively coupled to a portion of an associated trailer, the monitoring circuit configured to detect a fault condition with the associated trailer;
a trailer wireless transceiver operatively coupled to the monitoring circuit;
a towing vehicle wireless transceiver operatively coupled to an associated towing vehicle, wherein the trailer wireless transceiver is configured to communicate wirelessly with the towing vehicle wireless transceiver.

4. The vehicle trailer monitoring system according to claim 3, wherein the monitoring circuit is configured to detect trailer brake malfunction or disconnection.

5. The vehicle trailer monitoring system according to claim 3, wherein the monitoring circuit is configured to detect trailer light malfunction or disconnection.

6. The vehicle trailer monitoring system according to claim 3, wherein the monitoring circuit is configured to detect a fault condition related to tongue weight

7. The vehicle trailer monitoring system according to claim 3, wherein the monitoring circuit is configured to detect a fault condition related to status of cargo disposed within the trailer.

8. The vehicle trailer monitoring system according to claim 3, wherein the monitoring circuit is configured to detect a fault condition related to of a status of a coupler coupling the trailer to the towing vehicle.

9. The vehicle trailer monitoring system according to claim 3, wherein the monitoring circuit is configured to detect a fault condition related to trailer yaw.

10. A wireless vehicle trailer control system comprising:
a towing vehicle wireless transceiver operatively coupled to a control harness of a towing vehicle; and
a trailer wireless transceiver operatively coupled to a trailer controller, the trailer wireless transceiver configured to receive wireless trailer control signals from the towing vehicle wireless transceiver.

11. The wireless vehicle trailer control system according to claim 10, wherein the control signals are related to trailer light operation.

12. The wireless vehicle trailer control system according to claim 10, wherein the control signals are related to trailer braking.

13. The wireless vehicle trailer control system according to claim 10, wherein the control signals are related to trailer stability control or yaw.

14. A wireless brake monitoring system for a vehicle trailer comprising:
a trailer brake monitoring circuit configured to cooperate with an associated trailer brake controller and to detect a trailer brake failure condition;
a trailer wireless transceiver operatively coupled to the trailer brake monitoring circuit;
a vehicle transceiver operatively coupled to an associated towing vehicle, the first vehicle transceiver being configured to communicate wirelessly with the trailer wireless transceiver.

15. The wireless brake monitoring system according to claim 14, further comprising:
a driver alert module configured to wirelessly receive trailer brake failure condition information from the vehicle wireless transceiver and to display the received trailer brake failure condition information.

16. The wireless brake monitoring system according to claim 15, wherein the driver alert module is configured to provide an audible alert in response to receiving trailer brake failure condition information.

17. A trailer having lights, electric brakes and a trailer controller operatively coupled to the lights and electric brakes, the trailer comprising:
a trailer fault detection circuit operatively coupled to the trailer controller, the trailer fault detection circuit configured to detect a fault condition with the lights and/or electric brakes of the trailer; and
a wireless transceiver operatively coupled to the trailer fault detection circuit, the transceiver being configured to wirelessly transmit fault detection information to a transceiver associated with a towing vehicle.

18. A trailer monitoring apparatus comprising:
a trailer fault detection circuit operatively coupled to a trailer controller, the trailer fault detection circuit configured to detect a fault condition an electrical system of a trailer; and
a wireless transceiver operatively coupled to the trailer fault detection circuit, the transceiver being configured to wirelessly transmit fault detection information to a transceiver associated with a towing vehicle.

19. The system according to claim 3 wherein the system operates without hard wiring between the towing vehicle and the trailer.
